(19) United States
(12) Patent Application Publication
(10) Pub. No.: US 2002/0033183 A1
(43) Pub. Date: Mar. 21, 2002

(54) METHOD AND APPARATUS FOR ENHANCED CHAMBER CLEANING

(76) Inventors: SHENG SUN, FREMONT, CA (US); QUANYUAN SHANG, SARATOGA, CA (US); SANJAY YADAV, REDWOOD CITY, CA (US); WILLIAM R. HARSHBARGER, SAN JOSE, CA (US); KAM S. LAW, UNION CITY, CA (US)

Correspondence Address: PATENT COUNSEL MS 2061, LEGAL AFFAIRS DEPARTMENT, APPLIED MATERIALS INC, 3050 BOWERS AVENUE, SANTA CLARA, CA, 95052

(21) Appl. No.: 09/322,893

(22) Filed: May 29, 1999

(51) Int. Cl. B08B 7/04; B08B 7/00; B08B 9/00

(52) U.S. Cl. 134/1.1; 134/1; 134/1.2; 134/1.3; 134/19; 134/22.1; 134/22.18; 156/345; 438/905; 134/902

(57) ABSTRACT

A system for processing substrates within a chamber and for cleaning accumulated material from chamber components is provided. The system includes a reactive species generator adapted to generate a reactive gas species for chemically etching accumulated material from chamber components, and a processing chamber having at least one fluoropolymer coated component which is exposed to the reactive species. Preferably to have the greatest impact on chamber cleaning efficiency, the fluoropolymer coated component(s) are large components such as a gas distribution plate or a backing plate, and/or a plurality of smaller components (e.g., a shadow frame, chamber wall liners, a susceptor, a gas conductance line) so as to constitute a large percentage of the surface area exposed to the reactive species. Most preferably all surfaces which the reactive species contacts are coated with fluoropolymer.

### FIELD OF THE INVENTION

The present invention relates to an improved method and apparatus for enhancing chamber cleaning rates. More specifically, the present invention relates to a method and apparatus for enhancing the effective etch rate of a reactive chemical species which etches accumulated materials from process chamber components.

### BACKGROUND OF THE INVENTION

The manufacture of liquid crystal displays, flat panel displays, thin film transistors and other semiconductor devices occurs within a plurality of chambers, each of which is designed to perform a specific process on the substrate. Many of these processes can result in an accumulation of material (e.g., material deposited on the substrate in layers, such as by chemical vapor deposition, physical vapor deposition, thermal evaporation, material etched from substrate surfaces, and the like) on chamber surfaces. Such accumulated material can crumble from the chamber surfaces and contaminate the sensitive devices being processed therein. Accordingly, process chambers must be cleaned of accumulated materials frequently (e.g., every 1-6 substrates).

To clean chamber surfaces, an in-situ dry cleaning process is preferred. In an in-situ dry cleaning process one or more gases are dissociated to form one or more reactive gas species (e.g., fluorine ions, radicals). The reactive species clean chamber surfaces by forming volatile compounds with the material accumulated on those surfaces. Unfortunately, as described further below, such chamber cleaning processes conventionally require considerable time and consume considerable amounts of cleaning gases, and thus undesirably increase the cost per substrate processed within a processing chamber. Further, large cleaning rate variations often are observed between processing chambers cleaned by identical cleaning processes. Accordingly, there is a need for an improved method and apparatus for etching accumulated material from chamber surfaces.

### SUMMARY OF THE INVENTION

The present inventors have discovered that chamber cleaning rates may be increased by as much as 20-100% when chamber surfaces exposed to reactive cleaning gas species are coated with a fluoropolymer (e.g., polytetrafluoroethylene (PTFE), a tetrafluoroethylene and hexafluoropropylene copolymer (FEP), a copolymer of tetrafluoroethylene and perfluoropropylvinyl ether (PFA)). The present invention therefore comprises a system for processing substrates within a chamber and for cleaning accumulated material from chamber components. The system includes a reactive species generator adapted to generate a reactive gas species for chemically etching accumulated material from chamber components, and a processing chamber having at least one flouropolymer coated component which is exposed to the reactive species. Preferably to have the greatest impact on chamber cleaning efficiency, the fluoropolymer coated component(s) include large components such as a gas distribution plate or a backing plate, and/or a plurality of smaller components (e.g., the chamber's shadow frame, wall liners, susceptor, gas conductance line, etc.) so as to constitute a large percentage of the surface area exposed to the reactive species. Most preferably all surfaces which the reactive species contacts are coated with a fluoropolymer.

By coating exposed chamber components with PTFE, FEP or PFA, not only have cleaning rate enhancements been observed, cleaning rate variations between processing chambers can be virtually eliminated, process chamber throughput increased significantly and the amount of precursor gas required for cleaning reduced. Because of the high costs associated with precursor gases such as NF₃, both monetarily and environmentally (e.g., global warming), any reduction in precursor gas consumption is beneficial.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a side elevational view of a processing system configured in accordance with the present invention.

### DETAILED DESCRIPTION OF THE PREFERRED EMBODIMENTS

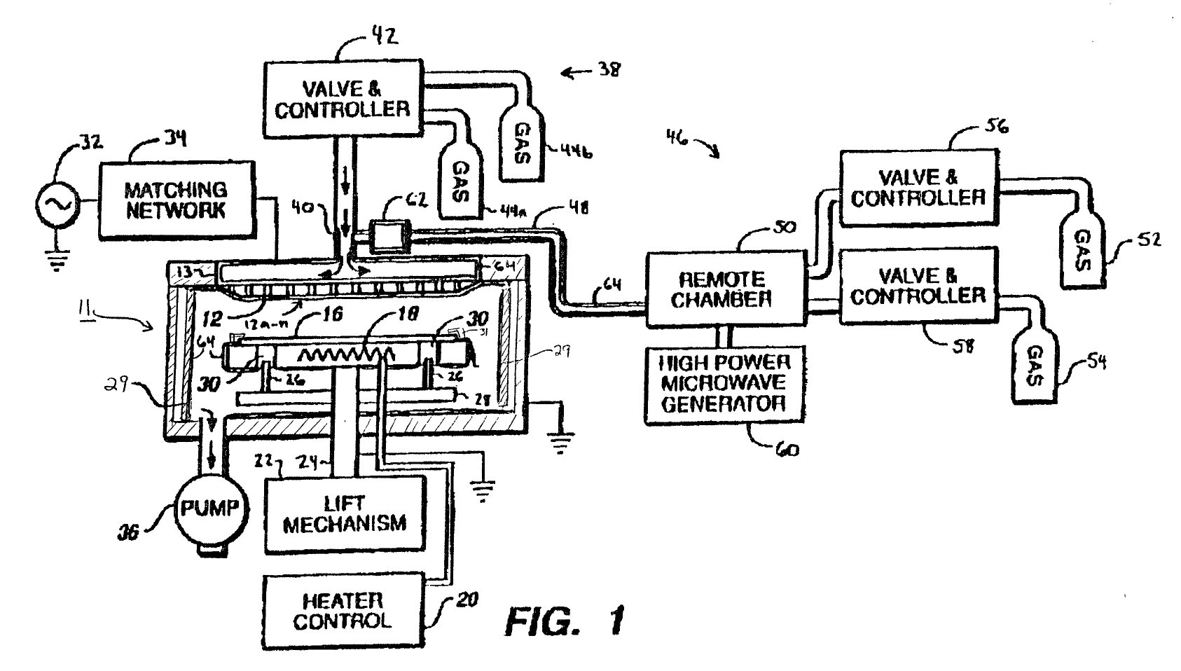

FIG. 1 is a side elevational view of a processing system 10 configured in accordance with the present invention. Any suitable processing system may be modified as described herein such as a model AKT-1600 PECVD System manufactured by Applied Kamatsu Technology and described in U.S. Pat. No. 5,788,778, which is hereby incorporated by reference herein in its entirety, the GIGAFILL™ processing system manufactured by Applied Materials, Inc. and described in U.S. Pat. No. 5,812,403, which is hereby incorporated by reference herein in its entirety, thermal deposition chambers and the like. For convenience an AKT-1600 PECVD System configured in accordance with the present invention is shown in FIG. 1. The AKT-1600 PECVD System is designed for fabricating active-matrix liquid crystal displays and may be used to deposit amorphous silicon, silicon dioxide, silicon oxynitrides and silicon nitride as is known in the art.

With reference to FIG. 1, the processing system 10 comprises a deposition chamber 11 having a gas distribution plate 12 having apertures 12a-u and a backing plate 13 adapted to deliver process gases and cleaning gases into the deposition chamber 11, and a susceptor 14 for supporting a substrate 16 to be processed within the deposition chamber 11. The susceptor 14 includes a heater element 18 (e.g., a resistive heater) coupled to a heater control 20 for elevating the temperature of the substrate 16 to a processing temperature and for maintaining the substrate 16 at the processing temperature during processing. A lift mechanism 22 is coupled to the susceptor 14 via a lift member 24 to allow the substrate 16 to be lifted from the susceptor 14. Specifically, a plurality of lift pins 26 (fixedly held by a lift pin holder 28) penetrate the susceptor 14 (via a plurality of lift pin apertures 30) so as to contact and lift the substrate 16 from the susceptor 14 when the susceptor 14 is lowered by the lift mechanism 22. The deposition chamber 11 further comprises a chamber wall liner 29 which blocks material from accumulating on the chamber wall and which can be removed and cleaned, and a shadow frame 31 which overhangs the substrate's edge and thereby prevents material from depositing or accumulating on the wafer's edge.

In addition to their above described functions, the gas distribution plate 12 and the susceptor 14 also serve as parallel plate upper and lower electrodes, respectively, for generating a plasma within the deposition chamber 11. For example, the susceptor 14 may be grounded and the gas distribution plate 12 coupled to an RF generator 32 via a matching network 34. An RF plasma thereby may be generated between the gas distribution plate 12 and the susceptor 14 through application of RF power supplied thereto by the RF generator 32 via the matching network 34. A vacuum pump 36 is coupled to the deposition chamber 11 for evacuating/pumping the same before, during or after processing as required.

The processing system 10 further comprises a first gas supply system 38 coupled to an inlet 40 of the deposition chamber 11 for supplying process gases thereto through the backing plate 13 and the gas distribution plate 12. The first gas supply system 38 comprises a valve controller system 42 (e.g., computer controlled mass flow controllers, flow meters, etc.) coupled to the inlet 40 of the deposition chamber 11, and a plurality of process gas sources 44a, 44b coupled to the valve controller system 42. The valve controller system 42 regulates the flow of process gases to the deposition chamber 11. The specific process gases employed depend on the materials being deposited within the deposition chamber 11.

In addition to the first gas supply system 38, the processing system 10 comprises a second gas supply system 46 coupled to the inlet 40 of the deposition chamber 11 (via a gas conductance line 48) for supplying cleaning gases thereto during cleaning of the deposition chamber 11 (e.g., to remove accumulated material from the various interior surfaces of the chamber 11). The second gas supply system 46 comprises a remote plasma chamber 50 coupled to the gas conductance line 48 and a precursor gas source 52 and a minor carrier gas source 54 coupled to the remote plasma chamber 50 via a valve controller system 56 and a valve controller system 58, respectively. Typical precursor cleaning gases include NF₃, CF₄, SF₆, C₂F₆, CCl₄, C₂Cl₆, etc., as are well known in the art. The minor carrier gas, if employed, may comprise any non-reactive gas compatible with the cleaning process being employed (e.g., argon, helium, hydrogen, nitrogen, oxygen, etc.). The precursor and minor carrier gas sources 52, 54 may comprise a single gas source if desired.

A high power microwave generator 60 supplies microwave power to the remote plasma chamber 50 to activate the precursor gas within the remote activation chamber (as described below). A flow restrictor 62 preferably is placed along the gas conductance line 48 to allow a pressure differential to be maintained between the remote plasma chamber 50 and the deposition chamber 11.

During cleaning of the deposition chamber 11, a precursor gas is delivered to the remote plasma chamber 50 from the precursor gas source 52. The flow rate of the precursor gas is set by the valve controller system 56. The high power microwave generator 60 delivers microwave power to the remote plasma chamber 50 and activates the precursor gas to form one or more reactive species (e.g., fluorine radicals) which travel to the deposition chamber 11 through the gas conductance line 48. The one or more reactive species then travel through the inlet 40, through the backing plate 13, through the gas distribution plate 12 and into the deposition chamber 11. A minor carrier gas may be supplied to the remote plasma chamber 50 from the minor carrier gas source 54 to aid in transport of the one or more reactive species to the chamber 11 and/or to assist in chamber cleaning or plasma initiation/stabilization within the deposition chamber 11 if an RF plasma is employed during chamber cleaning.

Exemplary cleaning process parameters for the deposition chamber 11 when an NF₃ precursor cleaning gas is employed include a precursor gas flow rate of about 2 liters per minute and a deposition chamber pressure of about 0.5 Torr. A microwave power of 3-12 kW, preferably 5 kW, is supplied to the remote plasma chamber 50 by the high power microwave generator 60 to activate the NF₃ precursor gas. Preferably the remote plasma chamber 50 is held at a pressure of at least 4.5 Torr and preferably about 6 Torr. Other cleaning process parameter ranges/chemistries are described in previously incorporated U.S. Pat. No. 5,788,778.

As previously described, common problems with conventional cleaning processes include low cleaning rates and large variations in cleaning rates between process chambers. The present inventors have discovered that cleaning rates and cleaning rate variations between chambers are dependent on the internal chamber surface condition, and that all internal surfaces between a remote plasma source (e.g., remote plasma chamber 50) and a chamber (e.g., deposition chamber 11) (“downstream surfaces”) affect cleaning rates. Specifically, a surface controlled deactivation process is believed to cause reactive species employed during cleaning (e.g., active etchant species such as F radicals) to combine to form non-reactive species (e.g., F₂ in the case of F radicals) which do not assist in chamber cleaning. This surface controlled deactivation process appears to occur at many material surfaces including both bare and anodized aluminum surfaces.

The present inventors have found that by coating one or more downstream components with PTFE, FEP or PFA, known generally as fluoropolymers, significantly higher cleaning rates are achieved and cleaning rate variations between chambers are virtually eliminated. Components found to have the most significant affect on cleaning performance include a chamber's gas distribution plate and backing plate. Components found to have a slight affect on cleaning performance include a chamber's shadow frame, wall liners, susceptor and gas conductance line. Components found to have little effect on cleaning performance include a chamber's microwave power supply, magnetron and microwave applicator. In order to affect an improvement in chamber cleaning rates, a certain percentage of the chamber components should be coated with a fluoropolymer. Although this percentage may vary, higher percentages are preferred to achieve faster cleaning rates, with 100% coating of exposed surfaces being most preferred. Note that an increase in cleaning rate (e.g., up to 15%) also can be achieved by using an RF plasma within a processing chamber in conjunction with a remote plasma source, i.e., by powering electrode 12 to form the radicalized gases entering from the remote plasma source, or secondarily introducing cleaning gases into a plasma. However, applied RF power should be limited to avoid damage to processing chamber components due to ion bombardment.

With reference to the processing system 11 of FIG. 1, to affect increased cleaning rate and reduced cleaning rate variations between the deposition chamber 11 and other deposition chambers (not shown), one or more downstream components of the processing system 11 are coated with a polytetrafluoroethylene (PTFE), a tetrafluoroethylene and hexafluoropropylene copolymer (FEP), or a copolymer of tetrafluoroethylene and perfluoropropylvinyl ether coating (“fluoropolymer coating 64”). As shown in FIG. 1, the interior surfaces of the deposition chamber 11, the gas distribution plate 12 the backing plate 13, the susceptor 14, the inlet 40, the gas conductance line 48, the chamber wall liner 29 and the shadow frame 31 are coated with the protective coating 64. Fewer components may be coated with the fluoropolymer coating 64 if desired.

With respect to the PECVD deposition chamber 11 of FIG. 1, the fluoropolymer coating 64 significantly increases the cleaning rate and significantly reduces chamber-to-chamber cleaning rate variations while neither producing process drift nor changes in the properties of PECVD films deposited within the deposition chamber 11. The fluoropolymer coating 64 is believed to cover surface adsorption sites at which the surface controlled deactivation process is believed to occur (e.g., maintaining a high and a uniform F radical concentration) and is also believed to reduce the amount of material deposited on component surfaces of the deposition chamber 11 during processing therein (e.g., reducing the amount of material that must be cleaned from component surfaces and the time required for material removal during cleaning).

The inventive fluoropolymer coating may be applied either in-situ or ex-situ. For in-situ application of PTFE coatings, a precursor gas such as CHF₃ may be employed to coat process chamber components using either a microwave or RF plasma. For example, within the processing system 10, a CHF₃ precursor gas source 52 may feed CHF₃ to the remote plasma chamber 50 wherein microwave power applied via the high power microwave generator 60 dissociates the CHF₃ into CF₂ and HF. The CF₂ and HF travel to the deposition chamber 11, and, en route, the CF₂ forms a fluoropolymer coating on the gas conductance line 48, the flow restrictor 59, the inlet 40, the backing plate 13, the gas distribution plate 12, the susceptor 14 and the interior surfaces of the deposition chamber 11. Alternatively, CHF₃ (and, if desired, CF₂ from the remote plasma chamber 50) may be flowed into the deposition chamber 11 while an RF plasma is generated within the deposition chamber 11 via the RF generator 32. As with the microwave plasma of the remote plasma chamber 50, the RF plasma within the deposition chamber 11 will dissociate CHF₃ into CF₂ which in turn will coat chamber components with a fluoropolymer coating. Thereafter, the chamber 11 may be heated (e.g., via the heater control 20 and the resistive heating element 18 or via any conventional heating mechanism capable of heating the entire chamber to the desired temperature) so as to melt/reflow the fluoropolymer coating. Preferably a heater temperature of about 500-800° F. is employed. In this manner, a uniform fluoropolymer coating, preferably about 0.5-10 μm in thickness, is formed on the chamber components.

For ex-situ application of protective coatings, chamber components such as the gas distribution plate 12 and the backing plate 13 preferably are uniformly coated with a thin layer (e.g., about 0.5 to 10 microns) of a PTFE, a FEP- or a PFA-contained in a solution or suspension fluid such as water, isopropyl alcohol, etc. After a few minutes of air drying or after an oven bake at 500-800° F. heater temperature, the chamber components may be reinstalled within the processing chamber. Care should be taken to prevent clogging of the small gas injection holes of the gas distribution plate due to capillary effect.

It should be noted that the inventive protective coating described herein differs from flouropolymers which undesirably accumulate over time on chamber surfaces as a result of flouropolymer deposition on a underlying substrate, or which are formed as a byproduct of certain CVD processes (i.e., are not continuously formed), in that such undesirably accumulated material is characteristically non-uniform, often exhibiting both areas of thick accumulation which can crumble from chamber surfaces, and areas where no material accumulates. Accordingly, such undesirable byproduct and deposited material accumulation must be cleaned from chamber surfaces. However, these undesirable fluoropolymer accumulations do not react with reactive fluorine gas species and therefore must be cleaned by other, less efficient means.

By coating downstream chamber components with PTFE, FEP or PFA, cleaning rate enhancements of as much as 100% have been observed, and cleaning rate variations between processing chambers have been virtually eliminated. Accordingly, process chamber throughput increases significantly with use of the present invention, and the amount of precursor gas required for cleaning is reduced. Because of the high costs associated with precursor gases such as NF₃, both monetarily (e.g. NF₃ presently costs $100/lb) and environmentally (e.g., NF₃ is a “global warming” gas,) reduction in precursor gas consumption is extremely beneficial. Moreover, flouropolymers are non-brittle, inexpensive and easy to apply, unlike coatings (e.g., AlF₃) which conventionally have been applied to prevent corrosion of chamber surfaces or to prevent accumulated material from crumbling therefrom.

The foregoing description discloses only the preferred embodiments of the invention, modifications of the above disclosed apparatus and method which fall within the scope of the invention will be readily apparent to those of ordinary skill in the art. For instance, while the present invention has been described with reference to a PECVD chamber, it will be understood that the invention has applicability to a wide variety of process chambers including thermal deposition chambers. Additionally, cleaning processes employing reactive species (e.g., reactive species generated by an RF plasma within a process chamber, or remote plasma source generated reactive species etc.) may be improved by employing the fluoropolymer coatings described herein. Finally, although any fluoropolymer is believed to enhance cleaning when applied as described herein, the fluoropolymers PTFE, FEP and PFA have been found to significantly enhance cleaning and are preferred.

Accordingly, while the present invention has been disclosed in connection with the preferred embodiments thereof, it should be understood that other embodiments may fall within the spirit and scope of the invention, as defined by the following claims.

The invention claimed is:

1. A gas distribution plate adapted to distribute gas as the gas flows into a processing chamber, the gas distribution plate comprising:
a base having a plurality of apertures formed therein; and
a continuously formed fluoropolymer coating over the base material.

2. The apparatus of claim 1 wherein the fluoropolymer coating is approximately 0.5-10 μm thick.

3. A backing plate adapted to distribute gas as the gas flows into a processing chamber, the backing plate comprising:
interior surfaces that are exposed to gas entering the chamber; and
a fluoropolymer coating over a portion of the interior surfaces.

4. The apparatus of claim 3 wherein the fluoropolymer coating is approximately 0.5-10 μm thick.

5. A system for processing a substrate within a chamber and for cleaning accumulated material layers from components of the chamber, comprising:
a reactive species generator adapted to generate a reactive species for chemically etching accumulated material; and
a processing chamber coupled to the reactive species generator and having at least one component having a continuously formed fluoropolymer coating thereon which is exposed to reactive species generated by the reactive species generator during cleaning.

6. The system of claim 5 wherein the processing chamber has a plurality of components which are exposed to the reactive species, wherein a percentage of the components exposed to the reactive species have a continuously formed fluoropolymer coating, and wherein the percentage is sufficient to increase the cleaning rate of the chamber.

7. The system of claim 6 wherein the percentage of coated components is sufficient to increase the cleaning rate of the chamber by at least 20%.

8. The system of claim 5 wherein the at least one fluoropolymer coated component comprises a gas distribution plate having a plurality of apertures through which gas enters the deposition chamber.

9. The system of claim 5 wherein the at least one fluoropolymer coated component comprises a backing plate.

10. The system of claim 8 wherein the at least one fluoropolymer coated component further comprises a backing plate.

11. The system of claim 5 wherein the at least one fluoropolymer coated component comprises a shadow frame.

12. The system of claim 5 wherein the at least one fluoropolymer coated component comprises a chamber wall liner.

13. The system of claim 5 wherein the at least one fluoropolymer coated component comprises a susceptor.

14. The system of claim 5 wherein the at least one fluoropolymer coated component comprises a gas conductance line adapted to conduct a reactive species from the reactive species generator to the processing chamber.

15. A method for cleaning a processing chamber via a reactive species which chemically etches accumulated materials from chamber components, the method comprising:
providing a processing chamber adapted to perform a process by which material accumulates on chamber components;
supplying the processing chamber with at least one fluoropolymer coated component; and
cleaning the processing chamber with a reactive species which chemically etches accumulated material from chamber components;
wherein the fluoropolymer coated component is exposed to the reactive species.

16. A method of cleaning a processing chamber using a reactive species, the method comprising:
flowing an amount of fluoropolymer precursor gas into the processing chamber;
generating a plasma within the processing chamber so as to form fluoropolymer on chamber components;
heating the processing chamber so as to melt the fluoropolymer and form a fluoropolymer coating on the chamber components, wherein the amount of fluoropolymer precursor gas is controlled so as to form a uniform fluoropolymer coating of approximately 0.5-10 μm on the chamber components;
thereafter processing one or more substrates within the processing chamber; and
thereafter flowing into the processing chamber reactive species and thereby cleaning accumulated material from the chamber components.

17. The method of claim 16 wherein the fluoropolymer coating is continuously formed.

18. The method of claim 1 wherein the fluoropolymer precursor gas is CHF₃.

19. The apparatus of claim 6 wherein the fluoropolymer is PTFE.

20. The apparatus of claim 6 wherein the fluoropolymer is FEP.

21. The apparatus of claim 6 wherein the fluoropolymer is PFA.
